(19) United States
(12) Patent Application Publication
(10) Pub. No.: US 2024/0376352 A1
(43) Pub. Date: Nov. 14, 2024

(54) Tape for Electrode Including Adhesive Part Having Pattern

(71) Applicant: LG Energy Solution, Ltd., Seoul (KR)

(72) Inventors: Jeong Eon Park, Daejeon (KR); Roun Kim, Daejeon (KR); Wook Hee Jang, Daejeon (KR)

(73) Assignee: LG Energy Solution, Ltd., Seoul (KR)

(21) Appl. No.: 18/689,147

(22) PCT Filed: Jul. 12, 2023
(86) PCT No.: PCT/KR2023/009916

§ 371 Date: Mar. 5, 2024

(30) Foreign Application Priority Data
Jul. 12, 2022 (KR) 10-2022-0085796

(51) Int. Cl. C09J 9/00; C09J 7/30; C09J 133/08; H01M 10/04; H01M 10/42

(52) U.S. Cl. CPC C09J 9/00; C09J 7/30; C09J 133/08; H01M 10/0431; H01M 10/4235; C09J 2301/20; C09J 2433/00

(57) ABSTRACT

A tape for an electrode includes a base film; and an adhesive part provided on a first surface of the base film, wherein the adhesive part includes an adhesive layer and an intaglio region, the intaglio region defining a pattern, provided over an entire second surface of the adhesive part.

### CROSS-REFERENCE TO RELATED APPLICATIONS

The present application is a national phase entry under 35 U.S.C. § 371 of International Application No. PCT/KR2023/009916 filed Jul. 12, 2023, which claims the benefit of Korean Patent Application No. 10-2022-0085796 filed in the Korean Intellectual Property Office on Jul. 12, 2022, the entire contents of which are incorporated herein by reference.

### BACKGROUND OF THE INVENTION

### Technical Field

The present invention relates to a tape for an electrode including an adhesive part having a pattern.

### Background Art

In recent years, as there has been an increased demand for portable electronic products such as laptop computers, video cameras, and mobile phones, as well as electric vehicles, batteries for energy storage, robots, and satellites, which has led to increased development of secondary batteries to power such products.

Examples of such secondary batteries include nickel-cadmium batteries, nickel-metal hydride batteries, nickel-zinc batteries, and lithium secondary batteries. Among such various secondary batteries, lithium secondary batteries are widely used in the field of advanced electronic devices because they are freely chargeable/dischargeable due to having almost no memory effect compared with nickel-based secondary batteries. Additionally, they have a very low self-discharge rate, a high operating voltage and a high energy density per unit weight.

In general, a lithium secondary battery is configured by stacking or winding an electrode assembly composed of a positive electrode, a negative electrode, and a separator interposed between the positive electrode and the negative electrode, embedding the stacked or wound electrode assembly in a metal can or a laminate sheet case, and injecting an electrolyte solution thereinto.

An electrode assembly having a positive electrode/separator/negative electrode structure constituting the secondary battery is largely divided into a jelly-roll type (wound type) electrode assembly and a stack type (stacked type) electrode assembly according to its structure. The jelly-roll type electrode assembly has a structure in which a separator is interposed between long sheet-like positive and negative electrodes coated with an active material, which is then wound, and a stack type electrode assembly has a structure in which a plurality of positive and negative electrodes with a predetermined size are sequentially stacked with a separator interposed therebetween. Among them, the jelly-roll type electrode assembly is easier to manufacture, has a high energy density per weight and is more structurally stable.

The jelly-roll type electrode assembly is composed of a positive electrode, a negative electrode, and a separator, and the positive electrode and the negative electrode are each formed by coating an electrode active material on a metal foil. Depending on the design, there are a coated portion coated with an electrode active material and an uncoated portion at which the foil is exposed, and a tape for an electrode may be applied on the positive electrode or negative electrode.

Since an adhesive layer of the tape for an electrode and the metal thin film have a strong interaction with each other, air bubbles are likely to be generated during attachment. In addition, it is difficult for the generated air bubbles to escape due to the strong interaction, and the generated air bubbles increase an outer diameter of the jelly-roll type electrode assembly, thereby causing potential can insertion defects and hindering structural stability of the secondary battery.

Therefore, there is a need for a method for promoting structural stability of a secondary battery.

### BRIEF SUMMARY OF THE INVENTION

### Technical Problem

In the present specification, a tape for an electrode including an adhesive part with a pattern and a secondary battery including the same are provided.

### Technical Solution

An exemplary embodiment of the present invention provides a tape for an electrode including: a base film; and an adhesive part provided on one surface of the base film, wherein the adhesive part includes an adhesive layer and an intaglio region, wherein the intaglio region is provided in a pattern, and wherein the pattern is provided on an entire surface of the adhesive part.

An exemplary embodiment of the present invention provides a secondary battery including an electrode assembly having a positive electrode, a negative electrode, and a separator provided between the positive electrode and the negative electrode, and the tape for an electrode.

### Advantageous Effects

The present invention has an effect of reducing generation of air bubbles by forming a path through which air bubbles generated inside can escape by coating the adhesive layer of the tape for an electrode in a pattern. In addition, since air bubbles can be easily removed without a roller, the present invention can be utilized in an existing process without an additional process.

### BRIEF DESCRIPTION OF THE DRAWINGS

FIG. 1 is a cross-sectional view of a tape for an electrode according to an exemplary embodiment of the present disclosure.

FIG. 2 is a cross-sectional view of a tape for an electrode according to another exemplary embodiment of the present disclosure.

FIG. 3 is a chart showing experimental results according to Example 1 and Comparative Example 1.

### DETAILED DESCRIPTION OF THE PREFERRED EMBODIMENTS

In the present specification, when a part is referred to as “including” a certain component, it means that the part can further include another component, without excluding another component, unless explicitly described to the contrary.

Throughout the present specification, when a member is referred to as being “on” another member, the member can be in direct contact with another member, or an intervening member may also be present.

In the present specification, when a portion is referred to as being connected to another portion, this includes not only a case where they are directly connected, but also a case where they are indirectly connected with another element interposed therebetween.

Hereinafter, preferred exemplary embodiments of the present invention will be described in detail with reference to the accompanying drawings. However, it should be understood that the embodiments of the present invention may be modified in various forms and the scope of the present invention is not limited to the embodiments described below. In the detailed description of the operating principle for the preferred exemplary embodiment of the present invention, when it is determined that a detailed description of related known functions or configurations may unnecessarily obscure the subject matter of the invention, the detailed description will be omitted. In addition, the same reference numerals are used for parts having similar functions and operations throughout the drawings.

An exemplary embodiment of the present invention provides a tape for an electrode including: a base film; and an adhesive part provided on one surface of the base film, wherein the adhesive part includes an adhesive layer and an intaglio region, wherein the intaglio region is provided in a pattern, and wherein the pattern is provided on an entire surface of the adhesive part.

In general, a jelly-roll type electrode assembly includes a positive electrode, a negative electrode, and a separator, and the positive electrode and the negative electrode are each formed by coating a metal foil with an electrode active material. Depending on the design, there may be a coated portion coated with an electrode active material and an uncoated portion at which an electrode active material is not coated, and the metal foil is exposed. A tape for an electrode may be applied on the uncoated portion.

Since an adhesive layer of the tape for an electrode and the metal foil, which is an adherend, have a strong interaction, air bubbles are easily generated during attachment. In addition, it is difficult for the air bubbles to escape due to the strong interaction between the adhesive layer and the metal foil, and the generated air bubbles increase an outer diameter of the electrode assembly, causing a defect during can insertion and hindering structural stability of the secondary battery.

Therefore, in order to minimize the generation of air bubbles while using the existing tape for an electrode, a roller should be inevitably introduced in a tape attaching process, and the addition of such a process may cause problems such as an increase in cost due to equipment remodeling and an increase in manufacturing time.

The present invention reduces generation of air bubbles by forming a path through which air bubbles generated inside the electrode assembly can escape by coating the adhesive layer of the tape for an electrode in a pattern form. In addition, since air bubbles can be easily removed without a roller, the present invention can be utilized in an existing process without an additional process.

In an exemplary embodiment of the present invention, the tape for an electrode includes a base film; and an adhesive part provided on one surface of the base film.

In an exemplary embodiment of the present invention, the base film may include one or more films selected from the group consisting of an acrylic film, a polyolefin film, a polyamide film, a polycarbonate film, a polyurethane film, a cellulose acetate film, and a polyester film, but is not limited thereto.

When a polyester film is used as the base film, one or more films selected from the group consisting of a polyethylene terephthalate film, a polyethylene naphthalate film, and a polybutylene terephthalate film may be used, and when a cellulose-based base layer is used as the base film 10, for example, as a base film including a cellulose acetate resin or a cellulose alkylate resin, a base film manufactured by applying a mixture including the resin to an extrusion or casting process may be used. As the cellulose alkylate, for example, cellulose acetate propionate, cellulose acetate butylate or the like may be used.

A method of manufacturing the base film is not particularly limited, and, for example, a usual film or sheet forming method such as a method of extruding or casting a raw material including the resin may be used. In this case, if necessary, a known additive may be included to the raw material including the resin.

A thickness of the base film as described above is not particularly limited, and may be, for example, about 10 μm to 200 μm, about 10 μm to 100 μm, about 10 μm to 50 μm, about 15 μm to 30 μm, or about 15 to 20 μm.

The base film is not formed with a hole or a pattern. Since the tape is fabricated in a roll form through a roll-to-roll process or attached to a battery through a roll-to-roll process, a pulling force is applied to the tape during this process. Therefore, when the base film is formed with a hole or pattern, problems such as breakage, stretching, and extension in pattern/hole of the film may occur. In addition, as described above, when the base film does not include a hole or pattern and only the adhesive layer in a pattern, the physical strength of the tape for an electrode is increased and stable quality can be maintained.

In the present invention, the intaglio region means a region having a thickness shallower than a thickness of the adhesive part because the adhesive layer is not provided on the adhesive part or the adhesive layer is recessed by a certain depth in a direction of the base film from a surface of the adhesive part.

In an exemplary embodiment of the present invention, the adhesive part includes an adhesive layer and an intaglio region.

The intaglio region may be provided in a pattern, and the pattern may be provided on an entire surface of the adhesive part. That is, the pattern may be provided over the entire surface of the adhesive part, rather than being provided only in a specific region of the adhesive part.

In an exemplary embodiment of the present invention, the pattern may be formed on a surface opposite to one surface of the adhesive part provided with the base film.

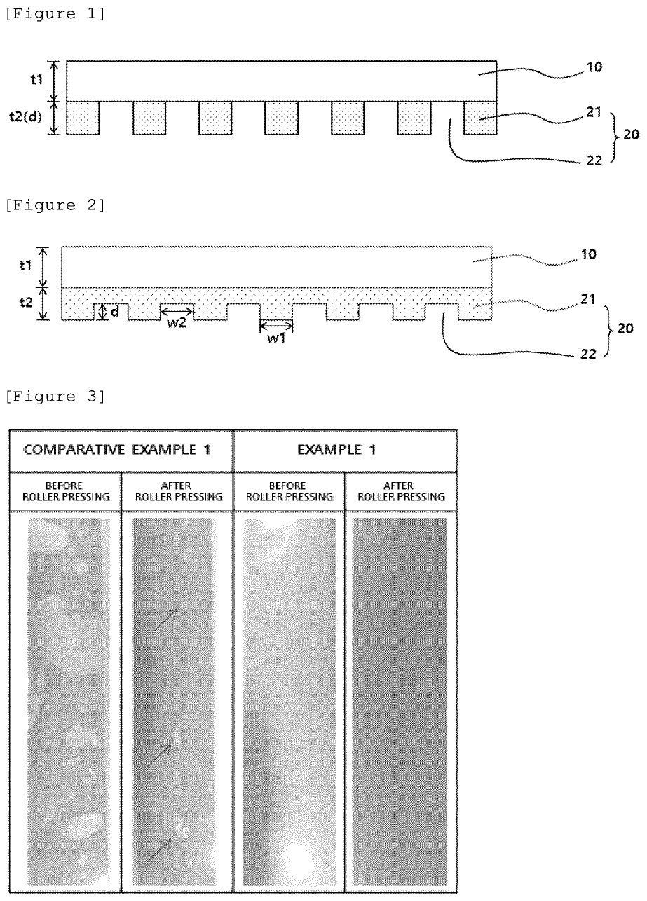

FIGS. 1 and 2 show a cross-section of a tape for an electrode according to an exemplary embodiment of the present invention.

Specifically, the formation of the intaglio region in a pattern may mean that the adhesive layer itself forms a pattern from the adhesive layer formed on one surface of the base film and the intaglio region.

In an exemplary embodiment of the present invention, the intaglio region may be a region of the adhesive part in which an adhesive layer is not provided.

FIG. 1 schematically shows a cross-section of a tape for an electrode when an adhesive part 20 includes an adhesive layer 21 and a region (intaglio region) 22 without an adhesive layer. Specifically, as shown in FIG. 1, a region provided with the adhesive layer 21 and a region (intaglio region) 22 without the adhesive layer are positioned at regular intervals or in a regular manner on one surface of the base film 10, so that the adhesive layer 21 itself forms a certain pattern.

In another exemplary embodiment, the intaglio region may be a region having a thickness shallower than a thickness of the adhesive part because the adhesive layer is recessed by a predetermined depth in a direction of the base film from the surface of the adhesive part.

FIG. 2 schematically shows a cross-section of a tape for an electrode when the adhesive part 20 includes an adhesive layer 21 and an intaglio region 22 in which the adhesive layer is recessed by a predetermined depth in a direction of the base film from the surface of the adhesive part. Specifically, as shown in FIG. 2, the intaglio region 22 is formed on the adhesive layer 21 provided on one surface of the base film 10, and the intaglio region 22 is formed in a certain pattern.

In addition, the pattern is positioned on the entire surface of the adhesive part in the tape for an electrode. That is, the adhesive part 20 including the adhesive layer 21 and the intaglio region 22 may be provided on the entire surface of one surface of the base material 10, and the pattern may be provided on the entire surface of the adhesive part 20. That is, the pattern is not provided only at a specific position on the adhesive part.

In an exemplary embodiment of the present invention, the pattern may be an intaglio pattern including the intaglio region 22 having an intaglio shape.

The intaglio pattern may be a closed figure pattern, a linear pattern, or a mixed pattern of a closed figure pattern and a linear pattern. The line of the intaglio pattern may be a straight line, a zigzag line, a wavy pattern, or the like. In an example, the intaglio pattern may be a lattice pattern or an S-shaped pattern, but is not limited thereto.

The closed figure of the intaglio pattern may be circular. When the closed figure of the intaglio pattern is circular, the intaglio region may be cylindrical or hemispherical. However, the present invention is not limited thereto, and other shapes that allow air bubbles to easily escape may be applied.

The pattern may be formed in a stripe shape, a wavy shape, or a dot shape using the shapes of the above-described patterns, but is not limited thereto, and a pattern shape used in the art may be employed as appropriate.

In an exemplary embodiment of the present invention, an average width (w2) of the intaglio region may be 0.1 mm or greater and 5 mm or less, and preferably 0.4 mm or greater and 3 mm or less. In an example, the average width may be 0.5 mm or greater and 3 mm or less, or 0.5 mm or greater and 2 mm or less. If the average width of the intaglio region is less than the above range, air bubbles can potentially escape and pattern shaping may be difficult. In addition, even if a pattern is formed, it may be difficult to remove air bubbles because a viscoelastic material included in the adhesive layer fills the pattern later. On the other hand, if the average width of the intaglio region exceeds the above range, the adhesive force may not be strong enough and an outer diameter rather may increase when attached to the electrode assembly. When the average width of the intaglio region satisfies the above range, it is possible to easily remove air bubbles when attaching the tape and to sufficiently secure the adhesive force of the tape, effectively preventing defects during can insertion by preventing an increase in the outer diameter of the electrode assembly when attached to the electrode assembly.

The upper limit of the average width of the intaglio region may be 5 mm, 4 mm, 3.5 mm, 3 mm, 2.5 mm, or 2 mm, and the lower limit may be 0.1 mm, 0.4 mm, or 0.5 mm.

In an exemplary embodiment of the present invention, the adhesive part includes a relief region. Specifically, a portion of the adhesive layer in which the intaglio region is not positioned, i.e., a region having the same thickness as the thickness of the adhesive part, is defined as a relief region.

In an exemplary embodiment of the present invention, an average width w1 of the relief region may be 0.1 mm or greater and 5 mm or less, specifically 1 mm or greater and 4 mm or less, and more specifically 1 mm or greater and 3.5 mm or less. If the average width of the relief region satisfies the above ranges, it is possible to easily remove air bubbles when attaching the tape and to sufficiently secure the adhesive force of the tape, effectively preventing defects during can insertion by preventing an increase in the outer diameter of the electrode assembly when attached to the electrode assembly.

The upper limit of the average width of the relief region may be 5 mm, 4 mm, 3.5 mm, 3 mm, or 2.5 mm, and the lower limit may be 0.1 mm, 0.5 mm, 0.8 mm, or 1 mm.

A ratio (w2:w1) of the average width (w2) of the intaglio region to the average width (w1) of the relief region is 1:1 to 1:4, 1:1.15 to 1:1.35, or 1:2 to 1.3. When the ratio (w2:w1) of the average width of the intaglio region to the average width of the relief region satisfies the above range, it is possible to easily remove air bubbles when attaching the tape and to sufficiently secure the adhesive force of the tape.

In an exemplary embodiment of the present invention, the intaglio region 22 of the pattern may occupy 1% or greater and 50% or less based on a total area of one surface of the base film provided with the adhesive part. Specifically, the intaglio region may occupy 10% or greater and 30% or less, and more specifically, 20% or greater and 30% or less. When the above range is satisfied, it is possible to easily remove air bubbles when attaching the tape and to sufficiently secure the adhesive force of the tape.

In an exemplary embodiment of the present invention, an average depth (d) of the intaglio region may be 10% or greater, 20% or greater, 30% or greater, or 40% or greater, preferably 50% or greater of a thickness (t2) of the adhesive part 20. In an example, the average depth of the intaglio region may be 60% or greater, 70% or greater, 80% or greater, 90% or greater, or 100% of the thickness (t2) of the adhesive part. The depth of the intaglio pattern may be equal to the maximum thickness (t2) of the adhesive part 20, and in this case, the intaglio region 22 in the intaglio pattern may refer to a region in which the adhesive layer is not provided, such as that shown in FIG. 1.

When the depth of the intaglio pattern satisfies the above range, there is an effect that air bubbles formed when attaching the tape for an electrode to the metal foil can more easily escape. If the depth of the intaglio pattern is less than the above range, the pattern may collapse due to the fluidity of the adhesive, and the holding force of the pattern is lowered.

In an exemplary embodiment of the present invention, the adhesive layer may be provided on 50% or greater, 60% or greater, or 70% or greater of the total surface area of the base film, or may be provided on the entirety of one surface of the base film. That is, when the depth (d) of the intaglio region is formed to be less than 100% of the thickness (t2) of the adhesive part, the adhesive layer may be provided on the entirety of one surface of the base film.

In an exemplary embodiment of the present invention, the pattern may be formed entirely on one surface of the adhesive layer or on one surface of the base film. That is, the adhesive part 20 including the adhesive layer 21 and the intaglio region 22 may be provided on the entirety of one surface of the base film.

The adhesive layer may include an adhesive composition. Specifically, the adhesive layer may include a cured product of the adhesive composition, and may include a polymer included in the adhesive composition in a crosslinked form.

The adhesive composition may include one or more selected from the group consisting of an acrylic resin, a urethane-based resin, an epoxy-based resin, a silicone-based resin, and a rubber-based resin. However, the present invention is not limited thereto, and any adhesive resin used in the art may be employed as appropriate.

In an example, the adhesive layer may include an acrylic resin, and for example, an acrylic polymer crosslinked by a multifunctional crosslinking agent.

As an acrylic polymer, a polymer having a weight average molecular weight (Mw) of 400,000 or more may be used. The weight average molecular weight refers to a conversion value with respect to standard polystyrene measured by gel permeation chromatograph (GPC). Unless specifically defined otherwise in the present specification, the term “molecular weight” means the weight average molecular weight. The upper limit of the molecular weight of the acrylic polymer is not particularly limited, and may be controlled within a range of 2.5 million or less, for example.

The acrylic polymer may include a (meth)acrylic acid ester monomer and a copolymerizable monomer having a crosslinkable functional group in a polymerized form. As the (meth)acrylic acid ester monomer included in the polymer, for example, an alkyl (meth)acrylate may be used, and alkyl(meth) acrylate having an alkyl group having 1 to 14 carbon atoms may be used in consideration of cohesive force, glass transition temperature, or adhesiveness of the adhesive. Examples of such a monomer may include one or two or more of methyl (meth)acrylate, ethyl (meth)acrylate, n-propyl (meth)acrylate, isopropyl (meth)acrylate, n-butyl (meth)acrylate, t-butyl (meth)acrylate, sec-butyl (meth)acrylate, pentyl (meth)acrylate, 2-ethylhexyl (meth)acrylate, 2-ethylbutyl (meth)acrylate, n-octyl (meth)acrylate, isooctyl (meth)acrylate, isononyl (meth)acrylate, lauryl (meth)acrylate, and tetradecyl (meth)acrylate may be exemplified, but are not limited thereto.

The copolymerizable monomer having a crosslinkable functional group is a monomer that can be copolymerized with the (meth)acrylic acid ester monomer or other monomers included in the polymer and can provide a main chain of the polymer after copolymerization with a crosslinking point capable of reacting with the multifunctional crosslinking agent. In the above, the crosslinkable functional group may be a hydroxyl group, a carboxyl group, an isocyanate group, a glycidyl group, an amide group or the like, and in some cases, may be a photocrosslinkable functional group such as an acryloyl group or a methacryloyl group. In the case of the photocrosslinkable functional group, it may be introduced by reacting a compound having a photocrosslinkable functional group with the crosslinkable functional group provided by the copolymerizable monomer. In the field of producing adhesives, various copolymerizable monomers are known that can be used depending on the desired functional group. Examples of such monomers may include monomers having a hydroxyl group such as 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 2-hydroxyethylene glycol (meth)acrylate or 2-hydroxypropylene glycol (meth)acrylate; monomers having a carboxyl group such as (meth)acrylic acid, 2-(meth)acryloyloxy acetic acid, 3-(meth)acryloyloxy propyl acid, 4-(meth)acryloyloxy butyric acid, acrylic acid dimer, itaconic acid, maleic acid and maleic anhydride; glycidyl (meth)acrylate, (meth)acrylamide, N-vinyl pyrrolidone or N-vinyl caprolactam, and the like, but are not limited thereto. One or two or more of these monomers may be included in the polymer.

The acrylic polymer may additionally include other functional comonomers in a polymerized form, if necessary, and examples thereof may include a monomer represented by Chemical Formula 1 below.

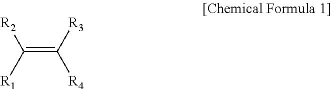

in Chemical Formula 1,

R1 to R3 each independently represent hydrogen or alkyl, R4 represents cyano, phenyl unsubstituted or substituted with alkyl, acetyloxy or COR5, in which R5 represents amino or glycidyloxy unsubstituted or substituted with alkyl or alkoxyalkyl.

In the definition of R1 to R5 in Chemical Formula 1, alkyl or alkoxy means alkyl or alkoxy having 1 to 8 carbon atoms, and is preferably methyl, ethyl, methoxy, ethoxy, propoxy or butoxy.

Specific examples of the monomer of Chemical Formula 1 may include (meth)acrylonitrile, N-methyl (meth)acrylamide, N-butoxymethyl (meth)acrylamide, styrene, methyl styrene, vinyl esters of carboxylic acids such as vinyl acetate, and the like, but are not limited thereto.

The acrylic polymer may be manufactured through, for example, solution polymerization, photo polymerization, bulk polymerization, suspension polymerization, emulsion polymerization, or the like.

The type of multifunctional crosslinking agent for crosslinking the acrylic polymer in the adhesive layer is not particularly limited. For example, among known crosslinking agents such as an isocyanate crosslinking agent, an epoxy crosslinking agent, an aziridine crosslinking agent, a metal chelate crosslinking agent or a photocrosslinking agent, an appropriate crosslinking agent may be selected according to the type of crosslinkable functional group present in the polymer. Examples of the isocyanate crosslinking agent may include diisocyanate such as tolylene diisocyanate, xylene diisocyanate, diphenylmethane diisocyanate, hexamethylene diisocyanate, isophorone diisocyanate, tetramethylxylene diisocyanate or naphthalene diisocyanate, a reactant of the diisocyanate and polyol, and the like, and trimethylol propane and the like may be used as the polyol. As the epoxy crosslinking agent, ethylene glycol diglycidyl ether, triglycidyl ether, trimethylolpropane triglycidyl ether, N, N, N′, N′-tetraglycidyl ethylenediamine, glycerin diglycidyl ether or the like may be used. Examples of the aziridine crosslinking agent may include N,N′-toluene-2,4-bis(1-aziridinecarboxamide), N,N′-diphenylmethane-4,4′-bis(1-aziridine carboxamide), triethylene melamine, bisisoprotaloyl-1-(2-methylaziridine), or tri-1-aziridinylphosphine oxide, and the like. Examples of the metal chelate crosslinking agent may include a compound in which polyvalent metal is coordinated with a compound such as acetylacetone or ethyl acetoacetate, and examples of the polyvalent metal may include aluminum, iron, zinc, tin, titanium, antimony, magnesium, vanadium or the like. As the photocrosslinking agent, multifunctional acrylate or the like may be used. Considering the type of crosslinkable functional group included in the polymer, one or two or more crosslinking agents may be used.

The adhesive layer as described above may be formed, for example, by coating a coating solution in which the acrylic polymer and the multifunctional crosslinking agent are mixed, and inducing a crosslinking reaction between the polymer and the multifunctional crosslinking agent under appropriate conditions.

In the adhesive layer, one or more additives selected from the group consisting of a coupling agent, a tackifier, an epoxy resin, a UV stabilizer, an antioxidant, a colorant, a reinforcing agent, a filler, an antifoaming agent, a surfactant and a plasticizer may be further included within a range that does not affect the desired effect.

A thickness of the adhesive layer may be, for example, 2 μm to 100 μm, 3 μm to 50 μm, 4 μm to 25 μm, 2 μm to 15 μm, 4 μm to 10 μm, 4 μm to 9 μm, 4 μm to 7 μm, or 5 μm to 7 μm. However, the thickness of the adhesive layer may be appropriately selected according to the intended use, and is not limited to the above range.

In an exemplary embodiment of the present invention, the tape for an electrode may further include a release film provided on one surface of the adhesive layer in order to protect the adhesive layer until the tape for an electrode is used.

Specifically, the release film may be additionally provided on a surface opposite to one surface of the adhesive layer in contact with the base film.

In an exemplary embodiment of the present invention, the release film may be a hydrophobic film. The release film is a thin layer for protecting the adhesive layer, and refers to a transparent layer attached to one surface of the adhesive film, and a film having excellent mechanical strength, thermal stability, moisture barrier properties, isotropic properties and the like may be used. For example, acetate-based such as triacetyl cellulose (TAC), polyester-based, polyethersulfone-based, polycarbonate-based, polyamide-based, polyimide-based, polyolefin-based, cycloolefin-based, polyurethane-based and acrylic resin films may be used, but the present invention is not limited thereto if the film is a commercially available silicon-treated release film.

The release film may be entirely removed when applied to a secondary battery.

In an exemplary embodiment of the present invention, when the tape for an electrode is attached so that the adhesive part is positioned on the metal foil, the air bubbles formed between the metal foil and the tape for an electrode may occupy an area less than 1% based on a total area of the tape for an electrode. Specifically, the area may be 0% or greater and 0.5% or less, and the smaller the area, the more advantageous it is.

In an exemplary embodiment of the present invention, when the tape for an electrode is attached so that the adhesive part is positioned on the metal foil, air bubbles may not be fully removed between the metal foil and the adhesive layer.

The type of metal foil is not limited, and a type commonly used in the art may be employed, as appropriate. For example, the metal foil may be a copper foil.

An exemplary embodiment of the present invention provides a secondary battery including an electrode assembly having a positive electrode, a negative electrode, and a separator provided between the positive electrode and the negative electrode, and a tape for an electrode.

When a general tape for an electrode is applied to a secondary battery, air bubbles may be generated at the time of attaching the tape to a metal thin film, and even if a roller process is introduced in order to remove the air bubbles, the pores may not be completely removed, and small and hard pores may remain. In addition, the introduction of the roller process increase cost due to equipment remodeling and increases manufacturing time.

When a tape for an electrode according to an exemplary embodiment of the present invention is applied to a secondary battery, the adhesive layer is coated in a pattern to form a path through which air bubbles generated inside can escape, thereby reducing the generation of air bubbles. In addition, since most of the pores are removed without introducing a roller process, stability and process advantages of the secondary battery can be promoted together.

In an exemplary embodiment of the present invention, the tape for an electrode may be attached on an uncoated portion of an electrode. Specifically, the tape may be attached on the uncoated portion of the electrode, attached on a step portion between a coated portion of the electrode where the electrode active material layer is provided and the uncoated portion of the electrode, or attached on an electrode tab positioned on the uncoated portion of the electrode, or may also be attached on an opposite surface of an electrode facing thereto. In addition, the tape may be attached between the regions described above, and may be attached to a portion where the tape is required while minimizing air bubbles, in addition to the portions described above.

In an exemplary embodiment of the present invention, the tape for an electrode may be attached to surround an outer circumferential surface of the electrode assembly, including a finishing portion where an outermost end portion of the outer circumferential surface is positioned. In this case, upper and lower end portions of the outer circumferential surface of the electrode assembly may be attached so that the electrode assembly is exposed.

The electrode assembly may include an electrode laminate including a positive electrode, a negative electrode, and a separator provided between the positive electrode and the negative electrode.

The electrode laminate may be formed as a jelly-roll type electrode assembly by winding the positive electrode, the negative electrode, and the separator together, or may be formed as a stack type electrode assembly or a stack and folding type electrode assembly. The separator serves to separate and electrically insulate the positive electrode and the negative electrode.

The electrode laminate according to an exemplary embodiment of the present invention may include an electrode including an electrode current collector.

The electrode may be provided in plural, and a separator may be provided between the plurality of electrodes.

The electrode may be a positive electrode or a negative electrode.

The electrode includes an electrode current collector, an electrode coated portion provided with an electrode active material layer on the electrode current collector, and an electrode uncoated portion not provided with the electrode active material layer on the electrode current collector. Specifically, the electrode coated portion may be formed by coating an electrode active material on one surface or both surfaces of the electrode current collector, and the electrode current collector may be exposed on the electrode uncoated portion that is not coated with an electrode active material.

On one surface of the electrode current collector, one or two or more electrode uncoated portions and one or two or more electrode coated portions may be provided. That is, the regions where the electrode uncoated portion and the electrode coated portion are provided may vary depending on a configuration of the battery.

The tape for an electrode according to an exemplary embodiment of the present invention may be attached on the electrode uncoated portion.

The positive electrode may include a positive electrode current collector and a positive electrode active material coated on the positive electrode current collector. Here, the positive electrode current collector may be composed of, for example, a foil made of aluminum (Al). In this case, the positive electrode active material may be composed of, for example, lithium manganese oxide, lithium cobalt oxide, lithium nickel oxide, lithium iron phosphate, or a compound or mixture containing one or more thereof.

The negative electrode may include a negative electrode current collector and a negative electrode active material coated on the negative electrode current collector. Here, the negative electrode current collector may be composed of, for example, a foil made of copper (Cu) or nickel (Ni). In this case, the negative electrode active material may be made of a material including, for example, artificial graphite. In addition, the negative electrode active material may be composed of, for example, lithium metal, lithium alloy, carbon, petroleum coke, activated carbon, graphite, a silicon compound, a tin compound, a titanium compound, or an alloy thereof.

The separator separates and electrically insulates the positive electrode and the negative electrode. Here, the positive electrode and the negative electrode may be wound together with the separator to form a jelly-roll type electrode assembly, or may be formed into a stack type electrode assembly or a stack and folding type electrode assembly.

The separator is made of an insulating material and may be alternately laminated with a positive electrode and a negative electrode. Here, the separator may be positioned between the positive electrode and the negative electrode and on outer surfaces of the positive electrode and the negative electrode.

Any separator material known in the art may be used, and particularly, a separator having high moisture-retention ability for an electrolyte solution as well as a low resistance to movement of electrolyte solution ions may be preferably used.

In addition, the separator may be made of a flexible material. The separator may be formed of, for example, a polyolefin-based resin film such as polyethylene and polypropylene having microporosity. As another example, a porous polymer film, for example, a porous polymer film manufactured from a polyolefin-based polymer, such as an ethylene homopolymer, a propylene homopolymer, an ethylene/butene copolymer, an ethylene/hexene copolymer, and an ethylene/methacrylate copolymer, or a laminated structure having two or more layers thereof may be used. In addition, a typical porous non-woven fabric, for example, a non-woven fabric formed of high melting point glass fibers, polyethylene terephthalate fibers, or the like may be used. Furthermore, a coated separator including a ceramic component or a polymer material may be used to secure heat resistance or mechanical strength, and the separator having a single layer or multilayer structure may be selectively used.

The tape for an electrode may be attached to an outer circumferential surface of the electrode assembly via the adhesive layer. The electrode assembly may be wound in a jelly-roll shape.

The separator or the electrode uncoated portion may be positioned on the outer circumferential surface of the electrode assembly.

Hereinafter, Examples will be described in detail to specifically describe the present specification. However, the Examples according to the present specification may be modified in other forms, and the scope of the present application is not construed as being limited to the following Examples. The Examples of the present application are provided to more completely explain the present specification to one skilled in the art.

### EXAMPLES

### Example 1

A monomer mixture composed of 98 parts by weight of n-butyl acrylate (n-BA) and 2 parts by weight of hydroxybutyl acrylate (HBA), and 0.02 part by weight of n-dodecanethiol as a chain transfer agent were put into a 1000 cc reactor equipped with a cooling device such that a nitrogen gas was refluxed and the temperature could be easily controlled, and 150 parts by weight of ethyl acetate (EAc) as a solvent was put into the reactor. Then, after purging with a nitrogen gas was performed at 60° C. for 60 minutes in order to remove oxygen, the reactor temperature was maintained at 60° C. After the mixture was homogenized, 0.04 part by weight of azobisisobutyronitrile (AIBN) as a reaction initiator was put into the reactor. The mixture was subjected to reaction for 8 hours to manufacture a polymer having a weight average molecular weight of 800,000. In the above, part by weight means weight percentage.

Based on 100 parts by weight of the polymer manufactured described above, 0.3 part by weight of tolylene diisocyanate adduct of trimethylolpropane as a multifunctional isocyanate-based crosslinking agent was put to an ethyl acetate solution, which was then diluted to an appropriate concentration in consideration of coating properties, and uniformly mixed.

The adhesive composition manufactured as described above was coated in a lattice pattern using an embossed release paper and dried on one surface of a poly(ethylene terephthalate) (PET) film (thickness: 20 μm), so that a tape for an electrode having an adhesive part with a thickness of 5 μm was manufactured. In this case, in the lattice pattern, the average width of the relief region was 1 mm, the average width of the intaglio region was 0.5 mm, and the average depth of the intaglio region was 3 μm.

After cutting the tape for an electrode into a size of 20 mm×100 mm, the tape was attached to a copper foil.

### Example 2

The adhesive composition manufactured in Example 1 was coated in an S-shaped pattern and dried on one surface of a PET film (thickness: 20 μm), so that a tape for an electrode having an adhesive part with a thickness of 5 μm was manufactured. In this case, in the S-shaped pattern, the average width of the relief region was 3 mm, the average width of the intaglio region was 1 mm, and the average depth of the intaglio region was 5 μm.

After cutting the tape for an electrode into a size of 20 mm×100 mm, the tape was attached to a copper foil.

### Comparative Example 1

The tape for an electrode was attached on the copper foil in the same manner as in Example 1, except that the adhesive composition manufactured in Example 1 was coated without a pattern on one surface of a PET film (thickness:

20 μm).

### Experimental Example

In Example 1, Example 2, and Comparative Example 1, it was confirmed whether pores were formed between the attached tape and the copper foil, and then, after repeatedly performing pressing with a 2 kg roller twice, it was confirmed whether the pores were removed. The results as shown in FIG. 3 were obtained, evaluated according to the following standard and recorded in Table 1.

Evaluation standard

It was confirmed whether the pore area having an average diameter of 2 mm or greater satisfied the following value.

pore area 10% or greater: X

pore area 1% or greater and less than 10%: Δ

Pore area less than 1%: O

TABLE 1

| | | | Comparative |
|---|---|---|---|
| | Example 1 | Example 2 | Example 1 |
| Whether or not | ◯ | ◯ | X |
| adhesive layer | (lattice pattern) | (S-shaped pattern) | |
| pattern is formed | | | |
| Before roller | ◯ | ◯ | X |
| pressing | | | |
| After roller pressing | ◯ | ◯ | Δ |

In Table 1 and FIG. 3, Examples 1 and 2 used a patterned adhesive layer, and it could be confirmed that no pores were formed when the tape was attached to the copper foil, and there was no difference before and after pressing.

On the other hand, in Comparative Example 1, it could be confirmed that when the tape was attached to the copper foil, the area where pores were formed between the adhesive layer and the foil was very wide, and the area of pores was reduced after being pressed twice with a roller, but the pores were not completely removed, and hard pores were rather formed. When hard pores are formed as in Comparative Example 1, the outer diameter of the electrode assembly may increase, causing can insertion defects.

Although the present invention has been described with reference to preferred embodiments, it will be understood by one skilled in the art that various modifications and variations can be made in the present invention without departing from the technical spirit and scope of the present invention.

### Identification of Select Reference Numerals

10: base film
20: adhesive part
21: adhesive layer
22: intaglio region

1. A tape for an electrode comprising:
a base film; and
an adhesive part provided on one surface of the base film,
wherein the adhesive part includes an adhesive layer and an intaglio region, the intaglio region defining a pattern provided over an entire surface of the adhesive part.

2. The tape for an electrode of claim 1, wherein the intaglio region lacks the adhesive layer.

3. The tape for an electrode of claim 1, wherein the intaglio region is a region having a smaller thickness than a thickness of the adhesive part, the adhesive layer being recessed by a in the second surface of the adhesive part.

4. The tape for an electrode of claim 1, wherein the pattern is at least one of a closed figure pattern, a linear pattern, and a mixture thereof.

5. The tape for an electrode of claim 1, wherein an average width of the intaglio region is in a range from 0.4 mm to 3 mm.

6. The tape for an electrode of claim 1, wherein the adhesive part comprises a relief region, and
wherein an average width of the relief region is in a range from 1 mm to 4 mm.

7. The tape for an electrode of claim 6, wherein a ratio of the average width of the intaglio region to the average width of the relief region is in a range from 1:1 to 1:4.

8. The tape for an electrode of claim 1, wherein an average thickness of the intaglio region is at least 50% of a thickness of the adhesive part.

9. The tape for an electrode of claim 1, wherein the base film includes one or more films selected from the group consisting of an acrylic film, a polyolefin film, a polyamide film, a polycarbonate film, a polyurethane film, a cellulose acetate film, and a polyester film.

10. The tape for an electrode of claim 1, wherein the adhesive layer includes an adhesive composition, and
wherein the adhesive composition includes one or more selected from the group consisting of an acrylic resin, a urethane-based resin, an epoxy-based resin, a silicone-based resin, and a rubber-based resin.

11. The tape for an electrode of claim 1, wherein when the tape for an electrode is attached to a metal foil, air bubbles formed between the metal foil and the adhesive part of the tape occupy an area less than 1% of a total area of the tape.

12. A secondary battery comprising:
an electrode assembly including a positive electrode, a negative electrode, and a separator positioned between the positive electrode and the negative electrode, and
the tape for an electrode according to claim 1.
